(19) United States
(12) Patent Application Publication
(10) Pub. No.: US 2024/0317150 A1
(43) Pub. Date: Sep. 26, 2024

(54) DECORATIVE COMPONENT HAVING ILLUMINATED INFORMATION DISPLAY

(71) Applicant: Lacks Enterprises, Inc., Grand Rapids, MI (US)

(72) Inventors: Thomas Hawkins, Grand Rapids, MI (US); Dave Walters, Grand Rapids, MI (US); Nick Hrnyak, Grand Rapids, MI (US)

(21) Appl. No.: 18/610,687

(22) Filed: Mar. 20, 2024

Related U.S. Application Data
(60) Provisional application No. 63/453,581, filed on Mar. 21, 2023.

(51) Int. Cl. B60R 13/02; B60K 35/21

(52) U.S. Cl. CPC B60R 13/02; B60K 35/21; B60R 2013/0287

(57) ABSTRACT

A decorative component, such as an interior or exterior automotive trim component having an exterior finish layer, includes an activatable illuminated display for providing status information related to the vehicle. The display may be in the form of a plurality of light areas arranged in a series of shapes or arranged to form or display text in accordance with the status being displayed. The light areas may be in the form of lenses that illuminate when activated, or they may be in the form of areas of light transmissive material exposed through the finish layer. The display may include multiple colors. The display may indicate a battery or fuel level, tire pressure, temperature, or the like. As the status of the vehicle changes, the lighted display changes thereby displaying the corresponding status of the vehicle.

### FIELD

The present disclosure relates to decorative components, such as decorative components having plated chrome finishes or other exterior finish layers. More particularly, the present disclosure relates to automotive trim pieces, such as interior or exterior trim pieces, having an illumination element.

### BACKGROUND

Decorative components having plated chrome finishes, or other decorative finish layers, have been in common use and are commercially available in a variety of industries, including automotive, appliance, consumer electronics, and other markets. As technology and consumer taste have matured, the desire for complicated parts and designs has evolved.

In particular, it has become desirable to incorporate a variety of functions into a single component, as a manner of adding additional aesthetic quality while reducing overall manufacturing processes. For example, an illumination component, such as an LED, can be integrated with an automotive trim component, such as a vehicle grille, interior or exterior trim component, or a roof rail. The inclusion of the LED may provide an additional aesthetic quality, increasing the pleasant appearance of the painted, coated, or chrome plated component, for example.

As consumer needs and/or desires increase or change, it is desirable to improve or vary the functionality and aesthetic qualities of such trim pieces. With regard to exterior trim pieces, such pieces are primarily visible to outside observers, including the vehicle operator prior to entering the vehicle, or outside observers. With regard to interior trim pieces, such pieces are primarily visible to vehicle occupants, including the driver and/or passengers.

During use of the vehicle, the vehicle will inherently undergo different vehicle states, both while in motion and also while stationary. However, such vehicle states may not be easily perceptible to the outside or inside observer. For electric vehicles for example, it may be unclear what the battery charge is, or how long until the battery will become charged. Similarly, for gas-powered vehicles, it may be unclear how much fuel remains. In another example, an outside or inside observer may not be able to perceive the vehicle speed by simple observation. It may be unclear from simple observation if all-wheel drive or four wheel drive is active. Similarly, an outside observer may not know whether the audio system is in use, or whether a mobile call is occurring. It may be unclear from simple external observation what the internal temperature of the vehicle is, and likewise may be unclear from inside the vehicle what the external temperature is. It may be unclear from simple observation whether the vehicle was recently operated. Other vehicle maintenance information may also be unclear from simple outside observation or from within the vehicle, including vehicle tire pressures.

While much of this information may be available to the operator of the vehicle, based on information provided on display screens or vehicle controls that are visible to the driver, such controls or displays are not readily visible to an outside observer or necessarily visible to other vehicle occupants, preventing the outside or inside observer from receiving vehicle status information in instances where such information may be beneficial.

In view of the above, improvements can be made to decorative components, such as automotive trim components, and in the display or provision of vehicle status information.

### SUMMARY

According to an aspect of the disclosure, a decorative component for an automotive vehicle includes an illuminated display, wherein the illuminated display provides vehicle status information.

In one aspect, a decorative component of a vehicle includes a substrate having an outermost exterior finish layer disposed on the substrate; a plurality of light areas disposed along the substrate, wherein the plurality of light areas are exposed through the finish layer and illuminable; a plurality of lights associated with the plurality of light areas; an activatable display defined by the plurality of light areas; wherein the activatable display is controllable and provides controlled illumination of one or more of the plurality of lights based on a detected vehicle status; wherein the controlled illumination corresponds to the detected vehicle status and varies in accordance with the detected vehicle status.

In one aspect, the finish layer is electroplated and the substrate is formed of a plateable resin. In one aspect, the substrate is non-conductive and plated with a conductive intermediate layer disposed below the finish layer. In one aspect, the decorative component is an exterior trim component fixed to a vehicle, wherein the activatable display is visible from outside of the vehicle. In one aspect, the exterior trim component is a vehicle roof rail, a door handle, a vehicle grille, a wheel cover, and/or a roof pad or module. In another aspect, the decorative component is an interior vehicle trim component.

In one aspect, the plurality of lights combine to emit a plurality of colors based on the detected vehicle status. In one aspect, each of the lights are controllable to emit multiple colors or a single color. In one aspect, the plurality of lights combine to emit a common color, wherein a quantity of the lights illuminated indicates the detected vehicle status. In one aspect, the plurality of lights combine to emit a common color, wherein the common color emitted by the plurality is controllable and changeable based on the detected vehicle status, wherein a change in color indicates the change in the detected vehicle status.

In one aspect, the plurality of lights indicate the detected vehicle status based on which color of a plurality of available colors are illuminated. In one aspect, the plurality of lights indicate the detected vehicle status based on which quantity of an available quantity of the plurality of lights are illuminated. In one aspect, the plurality of lights are illuminable to display text, including letters, numbers, and/or symbols.

In one aspect, the plurality of light areas are defined by an absence of the finish layer, wherein the substrate is exposed and light transmissive, and light is emitted through the substrate. In one aspect, the plurality of lights are optically isolated from each other such that light is emitted from a corresponding light area and blocked from a non-corresponding light area. In one aspect, the light areas include a lens that is separately attached to the substrate.

In another aspect, a method of displaying a vehicle status on a vehicle trim component includes: providing a plurality of illuminable light areas on a vehicle trim component, wherein the plurality of light areas are controllable and individually illuminable to provide a vehicle status; detecting a vehicle status related to the vehicle; providing a control signal to select lights of the plurality of lights based on the detected vehicle status; and illuminating the select lights according to a predefined illumination arrangement corresponding to the detected vehicle status.

In one aspect, the quantity of the select lights illuminated corresponds to the detected vehicle status. In one aspect, the plurality of lights are illuminated in a sequence and provide an animation effect. In one aspect, a color illuminated in the predefined illumination arrangement changes depending on the vehicle status.

In one aspect, the method includes detecting a change in the vehicle status and altering the predefined illumination arrangement based on the change in the vehicle status.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a schematic view of a trim component in the form of a vehicle roof rail, including a display providing vehicle status information, the display providing color-based information;

FIG. 2 is a schematic view of a trim component in the form of a vehicle grille, including a display providing vehicle status information, the display providing color-based information; and

FIG. 3 is a schematic view of a trim component in the form of a vehicle roof rail, including a display providing vehicle status information, the display providing text-based information;

FIG. 4 is a schematic view of a trim component in the form of an inside or outside door handle, including a display providing vehicle status information, the display providing text-based information;

FIG. 5 is a perspective view of a vehicle roof rail having a display providing vehicle status information, with the display being de-activated;

FIG. 6 is an enlarged perspective view of the vehicle roof rail of FIG. 5, illustrating a plurality of individual light areas in a de-activated state;

FIG. 7 is a perspective view of the vehicle roof rail of FIG. 6 in an illuminated state with the plurality of light areas illuminated; and

FIG. 8 is a perspective of the vehicle roof rail of FIG. 7 in an illuminated state, illustrating multiple colors being illuminated along the length of the roof rail.

### DETAILED DESCRIPTION

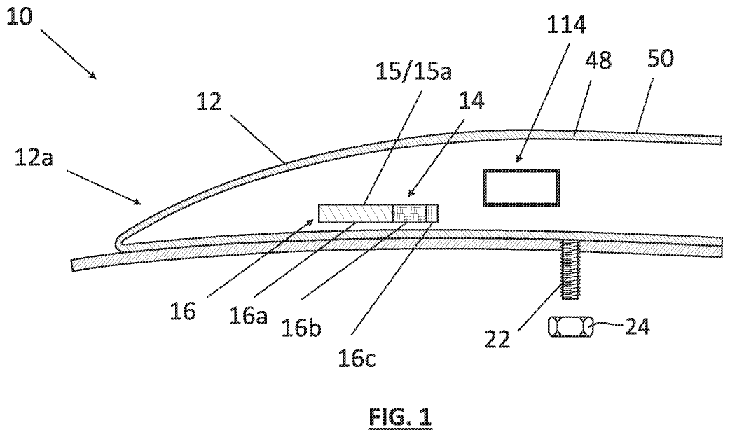

With initial reference to FIG. 1, a decorative component 10, such as a decorative plated or painted component of an automotive vehicle, is illustrated having a display 14 that illuminates to provide vehicle status information. It will be appreciated that the novel features and concepts disclosed herein are also applicable to other decorative components in other industries for which associated status information may be displayed. For the purposes of discussion, the majority of the description and figures will be directed to a vehicle roof rail, but it will be appreciated that other vehicle components, including other interior or exterior vehicle components, may also be used. For example, the present disclosure explicitly illustrates a vehicle grille and a vehicle door handle. However, the present disclosure is not limited to roof rails, door handles, and grilles. For example, a display according to the present disclosure may be provided on other trim components, such as appliques, wheel covers, etc. A display according to the present disclosure may be disposed on other interior vehicle trim components, or other exterior facing vehicle components, such as wheels, body paneling, lift gates, door panels, trunk/frunk covers, and the like.

FIG. 1 provides a schematic illustration of the decorative component 10, shown in the form of roof rail 12 having a display 14 visible to an observer. For example, in a vehicle having a traditional pair of roof rails 12 on opposite lateral sides of the vehicle, the display 14 may be disposed on an outboard side of the roof rail 12 (one or both) so that the display 14 can be seen by an observer standing at the side of the vehicle. However, it will be appreciated that roof rail systems or other vehicle structure may also extend laterally across the vehicle. Accordingly, the outboard side of the component 10 may be a forward side or a rearward side of the structure, such that the display 14 is viewable from an observer standing in front of the vehicle or behind the vehicle, respectively. Put another way, the display 14 may be exterior facing and visible to outside observers as they approach the vehicle. However, it will also be appreciated that the illuminable display 14 may also be disposed on surfaces or faces that are considered to be inward facing, such as the inboard side of a vehicle roof rail extending in the fore-and-aft direction of the vehicle, as these surfaces may also be visible to an observer and may therefore provide the benefit of displaying vehicle status information in addition to or alternatively to the outboard facing surfaces. In another aspect, the display 14 may be provided inside of the vehicle on an interior trim component.

In FIG. 1, the roof rail 12 is illustrated having a downwardly projecting stud 22 that extends through a roof of the vehicle, which is secured by a nut 24. It will be appreciated that a variety of securement arrangements and securement mechanisms may be used to secure the roof rail 12 to the vehicle. It will further be appreciated that the roof rail 12 may take on various shapes and forms and that FIG. 1 is not intended to be limiting in that regard.

FIG. 1 illustrates the display 14 at a first end 12a of the roof rail. A second end of the roof rail 12 is not explicitly shown. The display 14 may be located at this first end 12a, which may be the front end of the rail 12, such that the display 14 is easily viewed by the driver of the vehicle. However, the display 14 may also be located at other locations if desired, such as the middle of the roof rail 12 or the rear end of the roof rail 12.

The display 14 shown in FIG. 1 is in the form of a plurality of lights 16. The lights may be provided via a plurality of light areas 15, which may be in the form of a separate lens 15a, or may be in the form of bare space defined within a finish layer 50 applied to the component, such as chrome plating, a paint layer, or the like, with an underlying substrate 48 being a light transmissive resin such that light projects therefrom. The present disclosure references both lights 16 and light areas/lenses 15/15a. It will be appreciated that the reference to the lights 16 may refer to the lights areas/lenses 15/15a when the lights 16 are activated and illuminated and/or the activatable element of the lights 16 such as an LED or bulb, and that reference to the lights areas/lenses 15/15a generally refer to the outwardly facing structure through which the light waves generated by the light 16 will pass and be visible to the observer. When illuminated, reference to the lights 16 may also refer to the corresponding light area/lens 15/15 through which the particular light or lights 16 are visible.

The plurality of lights 16 may include a plurality of different colored lights, such as a first colored light 16a (for example, green), a second colored light 16b (for example, yellow), and a third colored light 16c (for example, red). Of course, it will be appreciated that fewer than three colors or more than three colors may be provided, with colors different than green, yellow, and red. The choice of colors may be selected to provide a particular type of information in accordance with predetermining signaling conventions. For example, “cool” colors may refer to low temperatures and “warm” colors may refer to high temperatures. Similarly, “warm” colors may be used to indicate a value approaching an extreme, such as a low battery or fuel level, or a high rate of speed, with “cool” colors indicating the opposite.

In one aspect, each of the plurality of lights 16 may have a fixed activatable color, such that when a particular light is illuminated, it is always illuminated in that color. For example, a green light when illuminated is always green. In such an arrangement, an array of lights 16 having fixed colors may be provided and illuminated in a line, where the number of illuminated lights 16 indicates the value being signaled. The array of lights may have different fixed colors at different locations along the line, such that when all of the lights 16 are illuminated, multiple colors are illuminated, and as fewer lights 16 are illuminated, fewer colors appear.

However, in another aspect, the lights 16 may be controllable to select a particular color in addition to being controllable to be activated or illuminated. For example, a given light of the plurality of lights 16 may be controlled to be activated to illuminate green, yellow, or red. For example, the lights 16 may be multi-color LEDs.

Preferably, the lights 16 are disposed within the component 10 and controllable by a connected controller (not shown), which may be disposed within the component 10 itself or within the vehicle and in remote (wired or wireless) communication with the lights 16. The lights 16 are preferably disposed within the component 10 in an optically isolated manner, such that activation of one light 16 is independent of the other lights 16 and that illumination provided by one does bleed into the light area of the others. However, in another aspect, multiple light areas 15 may be linked to given light 16, such that activating the light 16 will cause each of the associated areas 15 to become illuminated, giving the appears of multiple lights being activated in the illuminated section.

With reference to the example shown in FIG. 1, in the display 14 shown, the lights 16 have been activated to illustrate multiple colors to provide status information of the vehicle. The combination of green, yellow, and red illustrated in FIG. 1 may be indicative of the vehicle's battery charge, for example, with the green lights indicating that the battery is charged to a predetermined sufficient level. As the battery charge decreases, one or more of the green lights (16a in FIG. 1) may be de-activated so that fewer green lights are shown. As the battery level continues to deplete, all of the green lights may be deactivated, leaving only the yellow (16b) and red (16c) lights. As the level decreases more, only the red lights 16c may remain activated.

The above example functionality of the display can be performed both by lights 16 having dedicated colors (such as by a tinted lens or a single-color LED), or it may alternatively be performed by lights having selectable colors (such as a multi-color LED).

The above example referencing battery level may be similarly applied to other status indications, such as a fuel or gasoline level, brake pad wear, tire pressure, or the like.

In a similar example, the above functionality may be reversed, with red indicating a high level and green indicating a low level. For example, the lights 16 may be activated and controlled to indicate an internal temperature of the vehicle or an external temperature of the surroundings. Thus, at a higher temperature, yellow lights may be activated, and as the temperature increases, the red lights may be activated. Thus, a driver may be alerted prior to entering a vehicle during the summer that the vehicle is at a high temperature. Similarly, the driver can be signaled by the display 14 that the temperature inside the vehicle is low. This may be particularly useful in winter months when warming up the vehicle to indicate to the driver when a comfortable temperature has been reached. The temperature-based functionality may also be applicable to engine temperature or other temperatures of interest.

Similarly, the lights may be activated in the above manner to indicate a vehicle speed, with green lights indicating a relatively slower vehicle speed, and yellow and/or red lights indicating a relatively higher vehicle speed.

In another aspect, the plurality of lights 16 may all be the same fixed color, with the quantity of lights that are illuminated indicating the value of signal, without any color change. For instance, a low number of lights may indicate a low fuel level, charge level, speed, temperature, or the like, with higher quantities indicating higher values.

As described above, the display 14 can be controlled to increase or decrease the number of activated lights 16 having different colors to indicate a certain level-based vehicle status. In another aspect, the lights 16 may all remain activated, with all of the lights 16 changing or cycling through colors to indicate the vehicle status. For example, when the vehicle battery is charged above a threshold level, all of the lights 16 may be activated to be green. When the vehicle battery level drops below the threshold level, all of the lights 16 may change color to yellow, and then to red when falling below another threshold level. Similar activation of all lights 16 to cycle through different colors may be used for the other examples described above and other similar types of status indicators according to the scope of the present disclosure. The lights 16 may be controlled to activate or illuminate in series or another pattern to provide an animation effect.

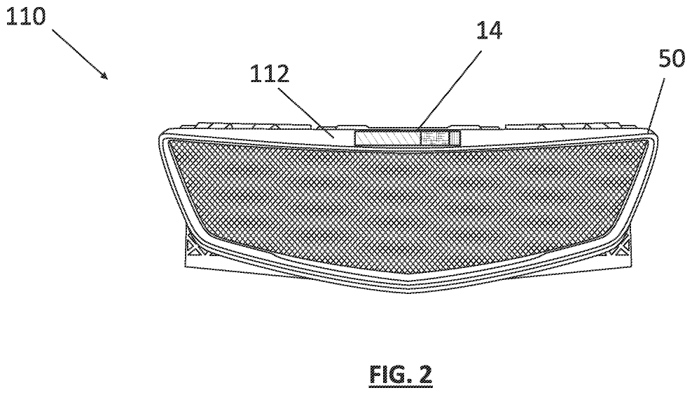

FIG. 2 illustrates another example embodiment of a decorative component 110, similar in functionality to the decorative component 10, but in the form of a vehicle grille 112. The component 110, as shown in FIG. 2, includes the display 14, which may operate in the manner described above. The grille 112 may have finish layer 50, such as an electroplated chrome or metal layer, as described above. The finish layer 50 may also be in the form of paint applied to the underlying substrate.

It will be appreciated that other decorative components, including other interior or exterior decorative vehicle components, are contemplated by the above disclosure, and may include other internal trim pieces or exterior trim pieces, for example, at various locations inside and/or around the vehicle. For example, in the case of a display for indicating tire pressure, the display 14 may be disposed at each of the wheels, for example on an adjacent trim piece, or on the wheel or wheel cover itself. The display 14 may be provided near a charging port or fuel port. The display 14 may be provided along the door trim. The display 14 may be provided on interior door trim near an interior door handle, near the glove box, center console, or arm rest, etc.

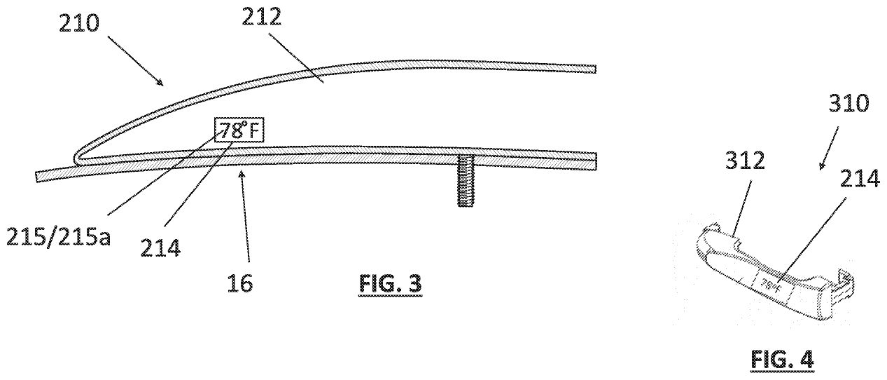

FIG. 3 illustrates another embodiment of a decorative component 210 in accordance with the present disclosure. The decorative component 210 is once again in the form of a roof rail 212, and includes a display 214. Unlike display 14, display 214 is configured to provide text/numeric based information. In one aspect, the display 214 may be in the form of a plurality of interconnected light areas 215 that are activatable to provide text-based information. The light areas may be lenses 215a, or bare/empty/negative space in the finish layer 50, which are arranged in a known pattern that can be selectively activated by the plurality of lights 16 to form a letter or number, similar to a digital clock. The light areas 215 can be made thin relative to the surrounding finish layer 50 and in such a manner that the display 214 may be inconspicuous when not activated. However, in another aspect, the display 214 may be in the form of an attached LED video screen capable of presenting a variety of shapes and text. In one aspect, the LED screen may be considered a plurality of lights 16 or light areas 15.

The display 214 may be activated and controlled to display the desired combination of letters, numbers, symbols, or the like corresponding to the vehicle status. For example, in FIG. 3, a temperature is being displayed on the display 214, with the text reading “78° F.”. This temperature may correspond, for example, to the interior of the vehicle. However, as described above, other temperatures may be the subject of the display 214, such as engine temperature or an exterior temperature.

Similarly, the display 214 may be activated to display text corresponding to the battery charge level or a fuel level, such as “85%.” Or, the text may be activated to display a tire pressure such as “35 PSI.” In the case of a battery or fuel level, a distance to empty may be displayed on display 214. The display 214 may be configured such that each of these various vehicle statuses may be provided by the same display, with the vehicle operator or other user capable of selecting which type of information to provide on the display based on personal choice. In another aspect, the display 214 may be of a fixed type, depending on its location relative to the vehicle. For example, the display 214 may be arranged to indicate fuel or charge level near the charging port or fuel port, while the display 214 may be arranged to indicate tire pressure near the wheels.

In the case of these text-based display options, the plurality of lights 16 may be selectively activated such that only the light areas 215 are activated that combine to form the desired text, while the other light areas 215 remain deactivated. As described above, the lights 16 and light areas 215 are preferably optically isolated from each other such that light provided by one light 16 does not bleed into the area of an adjacent light 16. Individual LEDs, bulbs, or the like may be provided in dedicated housings or cavities to isolate each activatable LED/bulb.

In addition to the selective activation to form desired text characters, the lights 16 may also be activated to display different colors. Thus, based on the status being communicated, the text can be colored in a similar manner. For example, for a low battery indication, the text may provide the battery percentage in a red color, and for a high battery level the text may be colored green. Other color schemes depending on the status being displayed can also be provided, such as using red text for high temperatures or blue text for cold temperatures. The different colored text may be provided by the same light 16 and at the same light area 215 via the use of a controllable and selectable multi-color LED.

It will be appreciated that the display 214, while shown disposed on roof rail 12, can also be used on other components, such as the grille 112 shown in FIG. 2, or other vehicle components and or vehicle trim pieces.

For example, as shown in FIG. 4, a component 310 is shown in the form of an interior or exterior door handle 312 having the text-based display 214. The functionality of display 214 is the same as that described above. It will be appreciated that the display 14, or other displays in accordance with the present disclosure may also be provided on the door handle 312 or other vehicle trim components.

The type of display (display 14, display 214, or other type of display) may be selected based on the type of trim component. For example, a display near the wheels to indicate tire pressure may be one type of display, while a display on the roof rail to indicate battery or fuel level may be another type of display, and a display on an exterior door handle to indicate vehicle temperature may be another type of display. It will be appreciated that these particular status indicators are examples, and that the various vehicle trim components are capable of indicating the variety of vehicle status contemplated by the present disclosure.

The displays 14 and 214 described herein may be provided as part of an integral or assembled component according to various manufacturing methods. For the sake of discussion, the component 10 and display 14 will be discussed generally, and it will be appreciated that the discussed structure and functionality may be applied to the other component or display types except where such details conflict.

The component 10 may be in the form of a plastic substrate 48 (see FIG. 1) formed or molded from a plateable plastic resin. The plateable resin may be light transmissive, such that the lights 16 may be disposed on the opposite side of the substrate from the light area 15 where the illumination projects. The substrate 48 may also be non-plateable and the exterior finish layer 50 may be painted or may otherwise coat the underlying substrate 48.

The substrate 48 may be electroplated according to known electroplating methods to apply a decorative metallic finish for the finish layer 50, such as a chrome finish, to the component 10. The substrate 48 in this approach may be formed of a plateable plastic resin, and may be treated prior to the electroplating process, such as by electroless application of a conductive layer of material to the substrate 48 to make certain portions of the substrate 48 conductive. Non-conductive portions of the substrate 48 are not part of the electroplating circuit and are therefore not plated. As described above, the finish layer 50 may also be painted or coated rather than electroplated.

The finish layer 50 is typically opaque, such that it will block light. Accordingly, the light area 15 may be defined at areas lacking the finish layer 50. The light area 15, having no overlying finish layer, can be provided in various ways, such as via the use of a separate lens 15a or via a lack of the finish layer such that the underlying substrate 48 is exposed. These approaches are further described below.

In one aspect, the light area 15 may be in the form of a separate lens 15a that is attached to the substrate 48, either before or after the plating/finishing process. If the lens 15a is attached to the substrate 48 prior to an electroplating process, the lens 15a may be made of a non-conductive resin such that the lens 15a will not become plated with material. If the lens 15a is provided after the molding process, it may be fixed mechanically using adhesives, fasteners, a snap fit, interference fit, sliding fit, etc.

In one aspect, the lens 15a is attached to the substrate 48 during the molding process as part of a multi-shot injection molding process. In this approach, a non-plateable resin is provided during the molding process in the areas of the component 10 where the lens 15a is arranged, while a plateable resin is provided for the other portions of the component 10. Other non-plateable resins, which are not used as lenses, may be provided for other purposes, such as providing a conductivity barrier between different sections of the plateable resin to allow for different surface finishes or finish layers to be plated on the component 10 via the isolation of plating circuits. Non-plateable resins may be provided in other areas, such as a non-visible backside of the part.

In one aspect, the substrate 48 may be non-light-transmissive, and may define a plurality of cavities or housings in which individual ones of the lights 16 may be placed, with the lenses 15a secured over the cavities/housings to enclose the lights 16 therein. The non-transmissive nature of the substrate in this case may operate to block light waves from bleeding into adjacent cavities.

In one aspect, the substrate 48 may be plateable and light transmissive such that the lights may be placed behind the substrate, and the lenses 15a may be integrated with or attached to the light transmissive substrate. A multi-shot process may be used to provide non-light transmissive portions within the body of the substrate 48 to provide a light blocking functions between light areas 15, if desired.

The lenses 15a, whether separately attached to the substrate or integrally molded as part of a multi-shot molding process, may include various diffusive characteristics to tailor the illumination characteristics of the component 10. For example, the lenses 15a may be textured on an outer surface, or may include an opaque structure at one side such that the light is visible from one direction but generally blocked from the opposite direction.

In one aspect, the lenses 15a may be tinted, such that the light emitted from the particular light area 15 has a consistent color when a given color is provided by the light source. For example, if white light is used in the light source, a red, yellow, or green tinted lens will consistently provide red, yellow, or green illumination. Alternatively, the lens 15a may be clear or untinted, with the color of the light 16 being configured to provide a predetermined color to provide a consistent illumination when activated, or the light 16 may be controllable (such as a multi-color LED) to provide a variety of colors. It will be appreciated that a tinted lens 15a may be used with a multi-color controllable light source, and that a corresponding illumination may be varied, while being tinted by the color of the lens 15a.

In another aspect, as mentioned briefly above, the light area 15 may be defined by negative space or a lack of metal plating/finish layer at the light area 15. In this aspect, the substrate 48 may be formed from a plateable and light transmissive resin. Single shot or multi-shot injection molding may be used to form the light transmissive substrate 48. The substrate 48, being plateable, may undergo one or more plating and/or electroplating processes to deposit the decorative finish on the component.

To create the negative space in the decorative finish layer 50 and define the light areas 15, the substrate 48 may be fully plated, painted, or otherwise finished with a decorative layer, with the finish layer 50 being removed to define the light areas 15 by exposing the underlying light transmissive substrate 48 as desired. In this aspect, the finish layer 50 on the substrate 48 may undergo laser ablation to remove the finish. The laser ablation process may provide for simple designs as well as intricate designs of the light areas 15, allowing for various symbols, patterns, text characters, or the like.

In one aspect, the substrate 48 may be plated with an intermediate layer that is conductive and receptive to current during the electroplating process. The creation of the negative space, for example via laser ablation, may be performed on this conductive layer prior to the electroplating process, such that the underlying resin in the areas of removal do not conduct current and do not become plated. In one aspect, the decorative finish layer (or the intermediate layer) may be removed mechanically without the use of a laser, such as via abrasion with a tool or the like, depending on the desired shape of the lights area 15. For example, a larger shape may be created without using the fine detail provided by a laser removal process.

It will be appreciated that other painting, coating, or finishing process may be used to provide the decorative finish layer 50, and furthermore than other processes for preventing the application of the finish layer 50 at specified areas, or for removing an applied finish layer in certain areas, may be applied. For example, masking may be applied to block application of the finish layer or underlying layers in some instances. A resist material may be provided on the substrate such that a particular coating does not adhere in the areas of the resist material.

As described above with reference to the lenses 15a, the light transmissive substrate 48 may include non-transmissive portions within the body of the substrate 48 to block and isolate light at one light area 15 relative to another. The non-transmissive portions may be provided in a multi-shot molding process or other process.

It will be appreciated that the above described features may be combined. For example, lenses 15a may be used along with light areas 15 defined by negative space. Tinted lenses 15a or light areas 15 may be combined with non-tinted features.

The lenses 15a or light areas 15 may be used both for shape-based displays 14, such as a series of blocks indicating a battery level or tire pressure, as well as text-based displays 214 providing a word or number associated with the information being displayed.

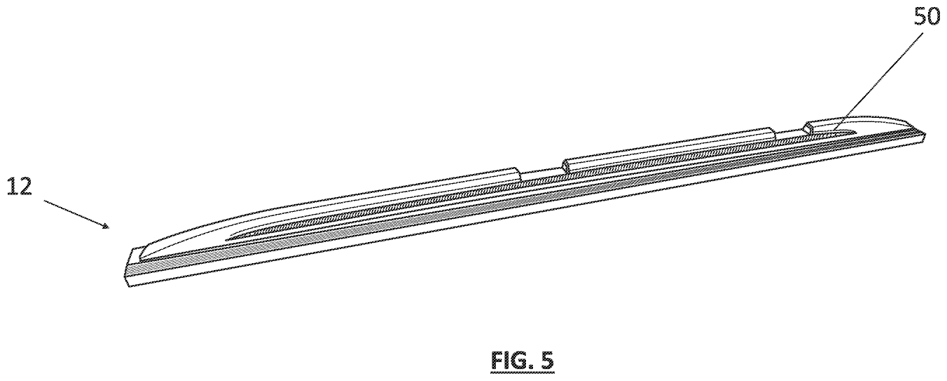

FIGS. 5-8 provide illustrations of the component 10 in the form of the roof rail 12 with different lighting states. In this example, the roof rail 12 includes a shape-based display including a plurality of light areas 15 in a series extending along the length of the roof rail 12. FIG. 5 illustrates the roof rail 12 in a deactivated state, where none of the lights are illuminated. The lights areas 15, when deactivated and viewed from a distance, may not be readily visible based on the size of the light area and the viewing distance, but are illustrated as visible in the FIG. 5 and extending along substantially the entire length of the roof rail 12. It will be appreciated that the structure and functionality of this roof rail example may be similarly applied to other interior or exterior vehicle trim components according to the present disclosure.

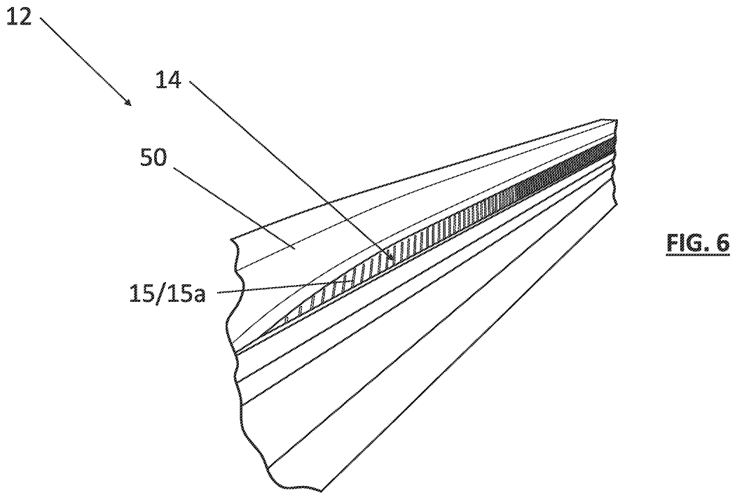

FIG. 6 is a close-up or enlarged view of the roof rail 12, illustrating one end of the roof rail 12. The light areas 15 (which may also be lenses 15a) may be non-tinted or tinted, as described above. For purposes of discussion, the light areas 15 may be considered non-tinted. The light areas 15 are in the form of a series of slots extending in a generally vertical direction, and extending along the majority of the length of the rail 12. It will be appreciated that this is one example, and different shapes of light areas and/or length of coverage along the rail 12 may vary.

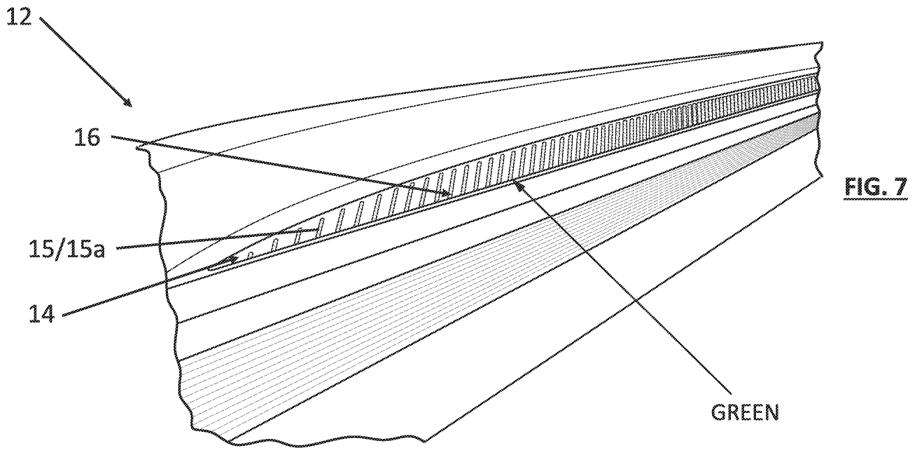

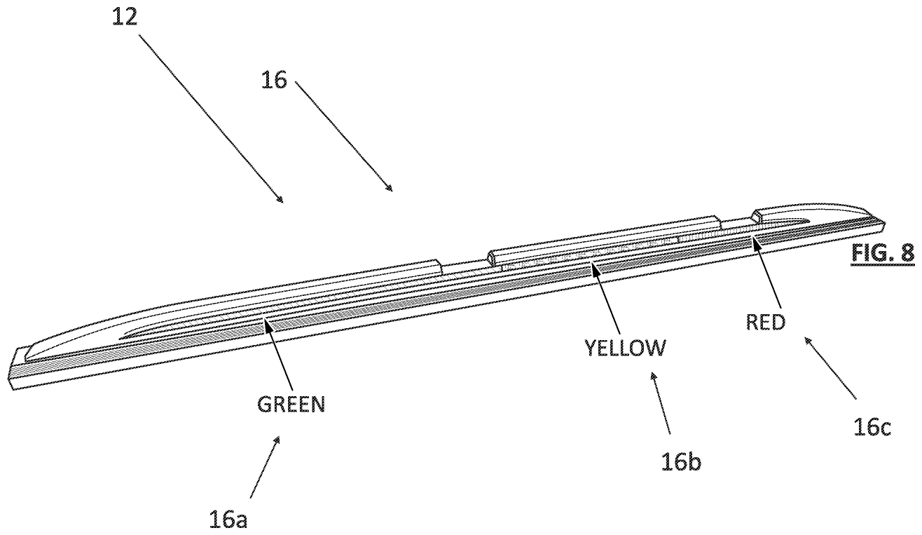

FIG. 7 illustrates the same end of the roof rail 12 as FIG. 6, in an activated and illuminated state. The lights 16 being illuminated through the light area 15 are illustrated as a single color in this area, for example green. However, these lights 16 could also be different color, cycle through multiple colors, and/or illuminate in a pattern to provide an animation effect. The lights 16 illustrated as a single color in FIG. 6 may also be interpreted as being a portion of the overall display 14, with the lights outside of the view shown being other colors, such as in the illustration of FIG. 1 and FIG. 8. At the end shown in FIG. 7, the lights 16 illuminate as green when activated. In this example, as the light areas 15 are non-tinted, the green illumination shown in FIG. 7 is provided by a green-colored light 16. The light 16 may be controlled to be green (such as a multi-color LED) or may be a single color light that always illuminates green (such as a green LED). The illustration of FIG. 7 may also represent the use of green tinted lens 15a in these locations, with illumination from the light source causing the green-colored appearance in combination with the tinted lens 15a.

FIG. 8 illustrates the full length of the roof rail 12 again, similar to FIG. 5, now shown in the activated state. The first end of the rail 12 illuminated in green (as in FIG. 7) is shown via lights 16a, along with the middle of the rail 12 being illuminated in yellow via lights 16b, and the opposite end illuminated in red via lights 16c. The plurality of lights 16 in these sections may be specifically colored lights corresponding to the desired illumination color, or they may be controllable multi-color lights. In another aspect, the lights 16 may be illuminated in this manner via the use of tinted lenses 15a.

Accordingly, in view of the above, the representation shown in FIG. 8 may indicate that the vehicle to which the rail 12 is attached has a full battery charge or a full fuel level. As the status of the vehicle changes, the quantity and/or color of the lights 16 may change to indicate a different status. Of course, various statuses may be indicated by the lights 16, with the alteration of the type of illumination having a control scheme tailored to the type of status being conveyed.

The illuminated example of FIG. 8 is but one example, and it will be appreciated that the various aspects of the present disclosure discussed above, including the different types of displays and assemblies, may be embodied in a similar manner on another roof rail or other trim component.

It will be appreciated that the present disclosure is not limited to the examples described above. For example, while various examples have been provided for guiding and/or isolating the light waves provided at the light areas 15 of the display 14, it will be appreciated that other mechanisms for guiding and/or isolating light waves may also be used, including various types of diffusion and the like. In this regard, Applicant's U.S. Pat. No. 11,148,585 describes the structure and function of light transmission for decorative components, the entire content of which is incorporated by reference in its entirety.

The use of laser ablation described above, such as to create the selectively light transmissive areas described above, is described in additional detail in Applicant's U.S. Patent Publication No. 2021/0222312, the entire content of which is incorporated by reference in its entirety.

As described above, the lights 16 are controllable to indicate a status via the display 14. Accordingly, the lights 16 are operatively connected to a controller (not shown) that receives signals related to the particular status being displayed. The controller, upon receiving the status signals, converts the status signals into the corresponding display, by sending operation signals to the lights 16, according to the programmed control scheme.

In a further embodiment, the vehicle trim component or module 10 may include a shared space where additional communication may occur. For example, the trim component 10 may include additional vehicle sensors 114 (see FIG. 1) that can detect one or more vehicle states or perform other detection functions, and may be configured to provide one or more signals to the vehicle controller. In one aspect, in addition to the illuminated display 14 provided on the trim component or module 10, a LIDAR sensor, RADAR sensor, camera, light sensor, proximity sensor, and/or the like can be provided in or on the trim component or module 10. A window through the surface finish of the component of module 10 may be provided, similar to the light areas or lenses described above, in instances where the surface finish could block or otherwise hinder the communication or other functionality of the particular sensor. These additional sensors 114 may be provided in the various types of trim components or modules 10 described herein. The window into the component 10 can be created similar to the light areas 15, as discussed above, via material removal and/or the use of a lens that is molded with or attached to the component body.

Obviously, many modifications and variations of the present disclosure are possible in light of the above teachings and may be practiced otherwise than as specifically described while within the scope of the appended claims. These antecedent recitations should be interpreted to cover any combination in which the inventive novelty exercises its utility.

What is claimed is:

1. A decorative component of a vehicle, the component comprising:
a substrate having an outermost exterior finish layer disposed on the substrate;
a plurality of light areas disposed along the substrate, wherein the plurality of light areas are exposed through the finish layer and illuminable;
a plurality of lights associated with the plurality of light areas;
an activatable display defined by the plurality of light areas;
wherein the activatable display is controllable and provides controlled illumination of one or more of the plurality of lights based on a detected vehicle status;
wherein the controlled illumination corresponds to the detected vehicle status and varies in accordance with the detected vehicle status.

2. The component of claim 1, wherein the finish layer is electroplated and the substrate is formed of a plateable resin.

3. The component of claim 2, wherein the substrate is non-conductive and plated with a conductive intermediate layer disposed below the finish layer.

4. The component of claim 1, wherein the decorative component is an exterior trim component fixed to a vehicle, wherein the activatable display is visible from outside of the vehicle.

5. The component of claim 4, wherein the exterior trim component is a vehicle roof rail, a door handle, a vehicle grille, a wheel cover, and/or a roof pad or module.

6. The component of claim 1, wherein the plurality of lights combine to emit a plurality of colors based on the detected vehicle status.

7. The component of claim 6, wherein each of the lights are controllable to emit multiple colors or a single color.

8. The component of claim 1, wherein the plurality of lights combine to emit a common color, wherein a quantity of the lights illuminated indicates the detected vehicle status.

9. The component of claim 1, wherein the plurality of lights combine to emit a common color, wherein the common color emitted by the plurality is controllable and changeable based on the detected vehicle status, wherein a change in color indicates the change in the detected vehicle status.

10. The component of claim 1, wherein the plurality of lights indicate the detected vehicle status based on which color of a plurality of available colors are illuminated.

11. The component of claim 1, wherein the plurality of lights indicate the detected vehicle status based on which quantity of an available quantity of the plurality of lights are illuminated.

12. The component of claim 1, wherein the plurality of lights are illuminable to display text, including letters, numbers, and/or symbols.

13. The component of claim 1, wherein the plurality of light areas are defined by an absence of the finish layer, wherein the substrate is exposed and light transmissive, and light is emitted through the substrate.

14. The component of claim 1, wherein the plurality of lights are optically isolated from each other such that light is emitted from a corresponding light area and blocked from a non-corresponding light area.

15. The component of claim 1, wherein the light areas include a lens that is separately attached to the substrate.

16. A method of displaying a vehicle status on a vehicle trim component, the method comprising:
providing a plurality of illuminable light areas on the vehicle trim component, wherein the plurality of light areas are controllable and individually illuminable to provide a vehicle status;
detecting a vehicle status related to the vehicle;
providing a control signal to select lights of the plurality of lights based on the detected vehicle status; and
illuminating the select lights according to a predefined illumination arrangement corresponding to the detected vehicle status.

17. The method of claim 16, wherein the quantity of the select lights illuminated corresponds to the detected vehicle status.

18. The method of claim 16, wherein the plurality of lights are illuminated in a sequence and provide an animation effect.

19. The method of claim 16, wherein a color illuminated in the predefined illumination arrangement changes depending on the vehicle status.

20. The method of claim 16, further comprising detecting a change in the vehicle status and altering the predefined illumination arrangement based on the change in the vehicle status.
